(19) United States
(12) Patent Application Publication
(10) Pub. No.: US 2015/0261019 A1
(43) Pub. Date: Sep. 17, 2015

(54) OPTICAL MODULATOR

(71) Applicant: Fujitsu Optical Components Limited, Kawasaki-shi (JP)

(72) Inventors: Yoshihiko YOSHIDA, Sapporo (JP); Masaharu Doi, Sapporo (JP); Yoshinobu Kubota, Yokohama (JP); Masaki Sugiyama, Sagamihara (JP)

(73) Assignee: Fujitsu Optical Components Limited, Kawasaki-shi (JP)

(21) Appl. No.: 14/630,024

(22) Filed: Feb. 24, 2015

(30) Foreign Application Priority Data
Mar. 11, 2014 (JP) 2014-047912

(51) Int. Cl. G02F 1/035; G02F 1/055; G02F 1/03

(52) U.S. Cl. CPC G02F 1/035; G02F 1/0316; G02F 1/0553

(57) ABSTRACT

An optical modulator includes a substrate, an electrode, and an optical waveguide. The substrate includes a flat portion and a protruding portion protruded from the flat portion. The electrode is supported by the protruding portion. The optical waveguide is formed inside the protruding portion and waveguides light to be modulated with a voltage applied to the electrode. The protruding portion contains a part, present on the side of the electrode, of a light distribution region over which the light waveguided by the optical waveguide is distributed. A height of a tip of the protruding portion from the flat portion is smaller than a width of the light distribution region along a protruding direction of the protruding portion. A width of the tip of the protruding portion is smaller than a width of the light distribution region along a direction perpendicular to the protruding direction of the protruding portion.

### CROSS-REFERENCE TO RELATED APPLICATION

This application is based upon and claims the benefit of priority of the prior Japanese Patent Application No. 2014-047912, filed on Mar. 11, 2014, the entire contents of which are incorporated herein by reference.

### FIELD

The embodiment discussed herein is directed to an optical modulator.

### BACKGROUND

Along with an increase in the speed and capacity of an optical communication system in recent years, an improvement in the modulation efficiency of an optical modulator has been studied. A configuration in which a protruding portion for supporting an electrode is protruded from a flat portion of a substrate and an optical waveguide for waveguiding light to be modulated is formed inside the protruding portion has been known as a configuration for improving the modulation efficiency of an optical modulator. According to this configuration, a mode field of light waveguided by the optical waveguide is confined within the protruding portion. Therefore, when a voltage is applied to the electrode on the protruding portion, the light confined within the protruding portion is efficiently modulated by the voltage. Note that an optical mode field refers to a region over which the light waveguided by the optical waveguide is distributed.

Patent Literature 1: International Publication Pamphlet No. WO 2010/095333 is introduced as the Prior Art Document.

According to the conventional configuration, however, no regard is given to suppressing light propagation loss while improving modulation efficiency.

In other words, in order to further improve the modulation efficiency, increasing the height of a tip of the protruding portion from the flat portion of the substrate can be considered in the conventional configuration. However, as the height of the tip of the protruding portion is increased, the length of a line of electric force extending from the electrode on the protruding portion is increased. As the length of the line of electric force extending from the electrode on the protruding portion is increased, the electric field generated in the optical waveguide formed inside the protruding portion is weakened. Therefore, there is a risk of a reduction in the modulation efficiency.

As the height of the tip of the protruding portion is decreased, on the other hand, the length of a line of electric force extending from the electrode on the protruding portion is reduced. However, as the height of the tip of the protruding portion is decreased, an electric field component in a direction perpendicular to the optical waveguide formed inside the protruding portion is weakened. Therefore, there is a risk of a reduction in the modulation efficiency.

Furthermore, in order to further improve the modulation efficiency, reducing the width of the tip of the protruding portion can be considered in the conventional configuration. If the width of the tip of the protruding portion is excessively reduced, however, light traveling from the optical waveguide formed inside the protruding portion toward the side surface of the protruding portion is scattered due to surface roughness on the side surface of the protruding portion. Therefore, when the width of the tip of the protruding portion is excessively reduced, there is a risk of an increase in light propagation loss.

### SUMMARY

According to an aspect of an embodiment, an optical modulator includes a substrate that has a flat portion and a protruding portion protruded from the flat portion; an electrode supported by the protruding portion; and an optical waveguide that is formed inside the protruding portion and waveguides light to be modulated with a voltage applied to the electrode, wherein the protruding portion contains a part, present on a side of the electrode, of a light distribution region over which the light waveguided by the optical waveguide is distributed, the protruding portion has a tip with a height thereof from the flat portion being smaller than a width of the light distribution region along a protruding direction of the protruding portion, and the tip of the protruding portion has a width smaller than a width of the light distribution region along a direction perpendicular to the protruding direction of the protruding portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an optical transmission device including an optical modulator according to a present embodiment;

FIG. 2 is a cross-sectional view taken along line A-A in the optical modulator illustrated in FIG. 1;

FIG. 3 is a diagram representing a relationship between a protruding portion height H and modulation efficiency;

FIG. 4 is a diagram for explaining a phenomenon in which the modulation efficiency is reduced as the protruding portion height H is increased;

FIG. 5 is a diagram for explaining a phenomenon in which the modulation efficiency is reduced as the protruding portion height H is decreased;

FIG. 6 is a diagram representing a relationship between a protruding portion width W and modulation efficiency; and

FIG. 7 is a diagram for explaining a relationship between the shape of the protruding portion and light propagation loss.

### DESCRIPTION OF EMBODIMENT

Preferred embodiment of the present invention will be explained with reference to accompanying drawings. Note that the disclosed technique is not limited by this embodiment.

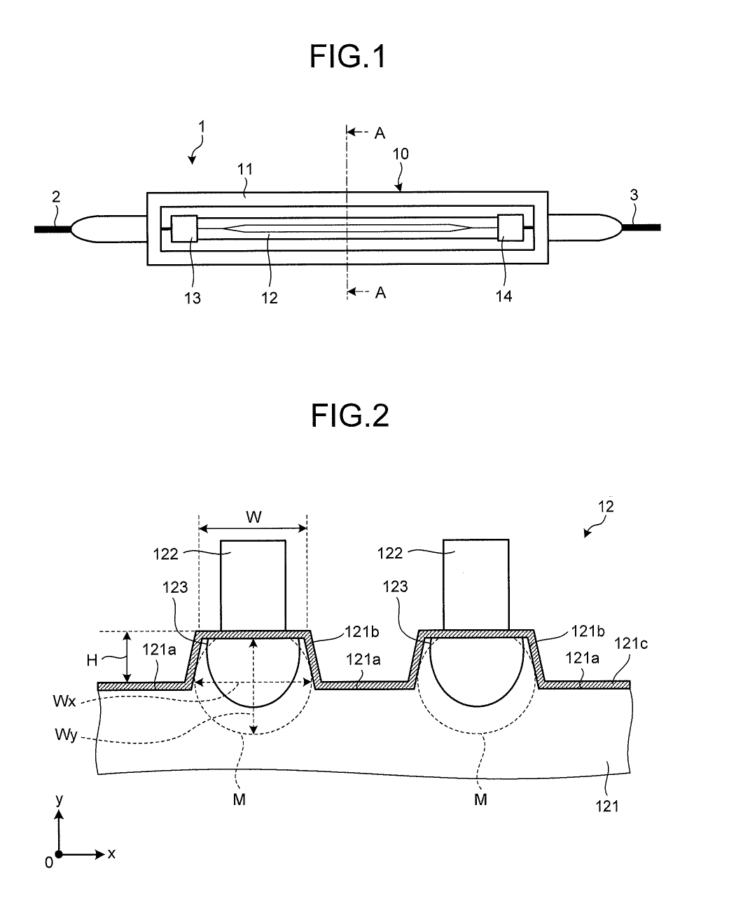

FIG. 1 is a diagram illustrating a configuration example of an optical transmission device including an optical modulator according to the present embodiment. As illustrated in FIG. 1, an optical transmission device 1 according to the present embodiment includes an optical fiber 2, an optical modulation device 10, and an optical fiber 3.

The optical fiber 2 inputs light emitted by a light source (not shown) into the optical modulation device 10.

The optical modulation device 10 includes a housing 11, an optical modulator 12, a connecting member 13, and a connecting member 14. The housing 11 is a housing for accommodating the optical modulator 12, the connecting member 13, and the connecting member 14. The optical modulator 12 modulates light inputted from the optical fiber 2 via the connecting member 13 so as to generate modulated light. The optical modulator 12 outputs the generated modulated light to the optical fiber 3 via the connecting member 14. The configuration of the optical modulator 12 will be described later in detail. The connecting member 13 is a member optically connecting the optical fiber 2 with the optical modulator 12. The connecting member 14 is a member optically connecting the optical modulator 12 with the optical fiber 3.

The optical fiber 3 transmits the modulated light inputted from the optical modulation device 10 to a subsequent stage.

Referring to FIG. 2, the configuration of the optical modulator 12 illustrated in FIG. 1 will be described next in detail. FIG. 2 is a cross-sectional view taken along line A-A in the optical modulator illustrated in FIG. 1. As illustrated in FIG. 2, the optical modulator 12 includes a substrate 121, electrodes 122, and optical waveguides 123.

The substrate 121 is a substrate formed from any one of LiNbO₃, LiTaO₃, and PLZT. The substrate 121 includes: a flat portion 121a; a protruding portion 121b protruded from the flat portion 121a; and a buffer layer 121c covering the flat portion 121a and the protruding portion 121b. The buffer layer 121c is formed from SiO₂, for example. The buffer layer 121c blocks light traveling from the optical waveguide 123 toward the electrode 122. Hereinafter, the flat portion 121a and the buffer layer 121c are collectively denoted as the “flat portion 121a” and the protruding portion 121b and the buffer layer 121c are collectively denoted as the “protruding portion 121b.”

The electrode 122 is supported by the protruding portion 121b. A voltage source (not shown) is connected to the electrode 122. The voltage source applies a predetermined voltage to the electrode 122. When the voltage is applied to the electrode 122, light being waveguided by the optical waveguide 123 is modulated, thereby obtaining modulated light.

The optical waveguide 123 is formed inside the protruding portion 121b. The optical waveguide 123 waveguides light to be modulated. The light waveguided by the optical waveguide 123 is distributed across a predetermined region. The region over which the light waveguided by the optical waveguide 123 is distributed is called a mode field. The optical mode field is an example of the light distribution region. In the example illustrated in FIG. 2, a mode field M of the light waveguided by the optical waveguide 123 is illustrated.

A relationship between the optical mode field M and the shape of the protruding portion 121b in the present embodiment will now be described. In FIG. 2, it is assumed that the protruding direction of the protruding portion 121b corresponds to a y-axis direction and a direction perpendicular to the protruding direction of the protruding portion 121b corresponds to an x-axis direction.

As illustrated in FIG. 2, the protruding portion 121b contains a part of the mode field M of the light waveguided by the optical waveguide 123 which is present on the side of the electrode 122. In other words, the protruding portion 121b contains only part of the mode field M of the light waveguided by the optical waveguide 123 which is present on the side of the electrode 122 and lets the other part of the optical mode field M excluding the above-described part be leaked into the inner side of the substrate 121. Such a shape of the protruding portion 121b reduces light traveling from the optical waveguide 123 formed inside the protruding portion 121b toward the side surface of the protruding portion 121b. As a result, light scattering due to surface roughness on the side surface of the protruding portion 121b is suppressed.

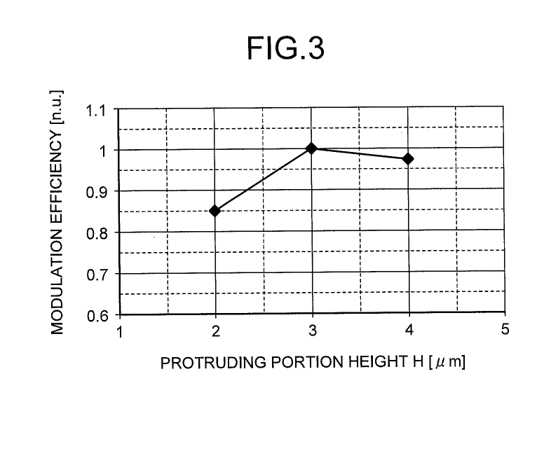

The height H of the tip of the protruding portion 121b from the flat portion 121a (hereinafter referred to as a “protruding portion height”) is smaller than the width Wy of the mode field M along the y-axis direction. The protruding portion height H is preferably smaller than 0.6 times the width Wy of the mode field M along the y-axis direction. The protruding portion height H is more preferably smaller than 0.6 times the width Wy of the mode field M along the y-axis direction and greater than 0. The reason why the protruding portion height H is made smaller than the width Wy of the mode field M along the y-axis direction will be described below with reference to FIGS. 3 to 5.

FIG. 3 is a diagram representing a relationship between the protruding portion height H and modulation efficiency. In FIG. 3, the horizontal axis thereof represents the protruding portion height H [μm] and the vertical axis thereof represents the modulation efficiency [n.u.] of the optical modulator 12. Note that the modulation efficiency of the optical modulator 12 represented in FIG. 3 is a value normalized with the use of the value when the protruding portion height H is 3 [μm]. In the description of FIG. 3, it is assumed that the width Wy of the mode field M along the y-axis direction is 7 [μm].

As represented in FIG. 3, the modulation efficiency of the optical modulator 12 varies according to the protruding portion height H. In the example represented in FIG. 3, the modulation efficiency of the optical modulator 12 reaches its maximum when the protruding portion height H is 3 [μm] which is smaller than 0.6 times the width Wy of the mode field M along the y-axis direction. Moreover, the modulation efficiency is reduced as the protruding portion height H is increased. Also, the modulation efficiency is reduced as the protruding portion height H is decreased.

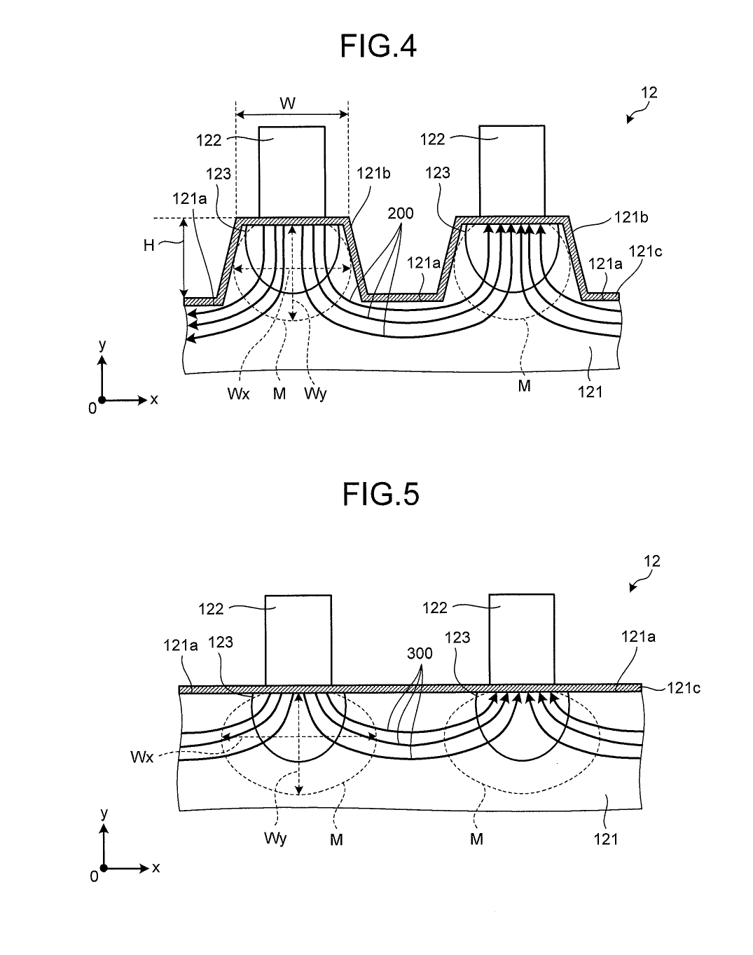

FIG. 4 is a diagram for explaining the phenomenon in which the modulation efficiency is reduced as the protruding portion height H is increased. As illustrated in FIG. 4, as the protruding portion height H is increased, the length of a line of electric force 200 extending from one electrode 122 to another electrode 122 is increased. If the length of the line of electric force 200 extending from one electrode 122 to another electrode 122 is excessively increased, the electric field generated in the optical waveguide 123 formed inside the protruding portion 121b is weakened. As a result, the modulation efficiency is reduced.

FIG. 5 is a diagram for explaining the phenomenon in which the modulation efficiency is reduced as the protruding portion height H is decreased. As illustrated in FIG. 5, when the protruding portion height H is decreased to 0, i.e., when there is no protruding portion 121b, the length of a line of electric force 300 extending from one electrode 122 to another electrode 122 is reduced. When there is no protruding portion 121b, however, an electric field component in the direction perpendicular to the optical waveguide 123 formed inside the protruding portion 121b is weakened. As a result, the modulation efficiency is reduced.

As a result of eager investigation made by the present inventors on the basis of the phenomena illustrated in FIGS. 4 and 5, it was found out that the modulation efficiency is improved when the protruding portion height H is smaller than the width Wy of the mode field M along the y-axis direction. In view of this, the protruding portion height H is set to a value smaller than the width Wy of the mode field M along the y-axis direction and greater than 0 in the optical modulator 12 of the present embodiment.

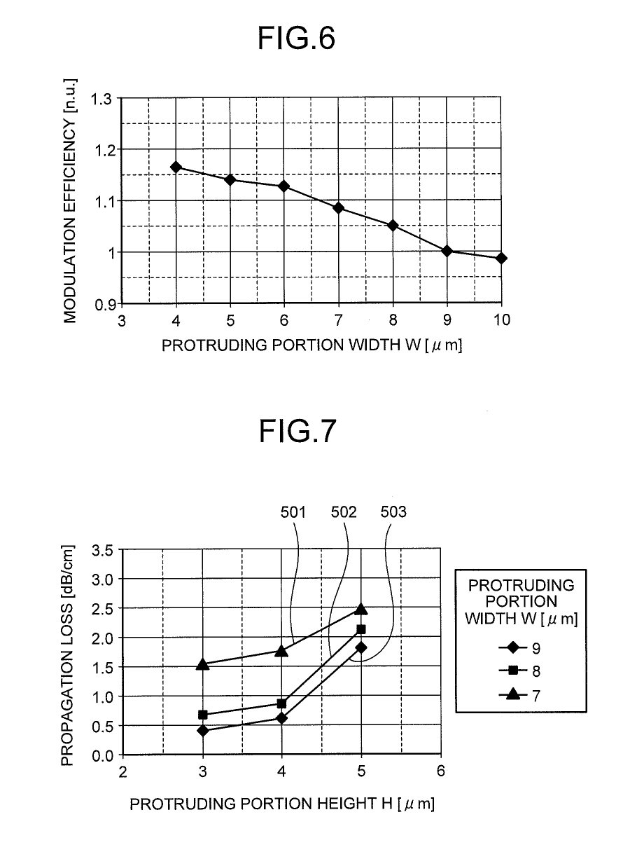

Moreover, the width W of the tip of the protruding portion 121b (hereinafter referred to as a “protruding portion width”) is smaller than the width Wx of the mode field M along the x-axis direction as illustrated in FIG. 2. The reason why the protruding portion width W is made smaller than the width Wx of the mode field M along the x-axis direction will be described below with reference to FIG. 6.

FIG. 6 is a diagram representing a relationship between the protruding portion width W and modulation efficiency. In FIG. 6, the horizontal axis thereof represents the protruding portion width W [μm] and the vertical axis thereof represents the modulation efficiency [n.u.] of the optical modulator 12. Note that the modulation efficiency of the optical modulator 12 represented in FIG. 6 is a value normalized with the use of the value when the protruding portion width W is 9 [μm]. Moreover, in the description of FIG. 6, it is assumed that the width Wx of the mode field M along the x-axis direction is 9 [μm]. In the description of FIG. 6, it is also assumed that the protruding portion height H is 3 [μm] which is smaller than 0.6 times the width Wy of the mode field M along the y-axis direction.

As represented in FIG. 6, the modulation efficiency is improved when the protruding portion width W is smaller than the width Wx of the mode field M along the x-axis direction, i.e., 9 [μm]. The reason for this can be considered that the mode field M is efficiently confined and compressed by the protruding portion 121b when the protruding portion width W is smaller than the width Wx of the mode field M along the x-axis direction. In view of this, the protruding portion width W is set to a value smaller than the width Wx of the mode field M along the x-axis direction in the optical modulator 12 of the present embodiment.

The relationship between the shape of the protruding portion 121b and light propagation loss will be described next. FIG. 7 is a diagram for explaining the relationship between the shape of the protruding portion and light propagation loss. In FIG. 7, the horizontal axis thereof represents the protruding portion height H [μm] and the vertical axis thereof represents light propagation loss [dB/cm] in the optical waveguide 123. Moreover, in FIG. 7, a graph 501 is a graph representing light propagation loss when the protruding portion width W is 7 [μm]. A graph 502 represents light propagation loss when the protruding portion width W is 8 [μm]. A graph 503 represents light propagation loss when the protruding portion width W is 9 [μm]. In the description of FIG. 7, it is assumed that the width Wx of the mode field M along the x-axis direction is 9 [μm] and the width Wy of the mode field M along the y-axis direction is 7 [μm].

As represented in FIG. 7, when the protruding portion height H is smaller than the value of 0.6 times the width Wy of the mode field M along the y-axis direction, i.e., 4.2 [μm], the light propagation loss is suppressed even when the protruding portion width W is smaller than the width Wx of the mode field M along the x-axis direction. Here, the light propagation loss is generated by the scattering of light traveling from the optical waveguide 123 formed inside the protruding portion 121b toward the side surface of the protruding portion 121b due to the surface roughness on the side surface of the protruding portion 121b. Therefore, when the protruding portion width W is smaller than the width Wx of the mode field M along the x-axis direction, there is a possibility of facilitating the light scattering due to the surface roughness on the side surface of the protruding portion 121b. According to the optical modulator 12 of the present embodiment, however, the protruding portion height H is smaller than the width of the mode field My along the y-axis direction and the protruding portion width W is smaller than the width of the mode field Mx along the x-axis direction. Such a shape of the protruding portion 121b reduces the overlapped portion between the optical mode field M and the protruding portion 121b. As a result, the light scattering due to the surface roughness on the side surface of the protruding portion 121b is less likely to occur. Therefore, the light propagation loss is suppressed according to the optical modulator 12 of the present embodiment.

As described above, according to the optical modulator 12 of the present embodiment, the protruding portion 121b of the substrate 121 contains part of the mode field M of the light waveguided by the optical waveguide 123 which is present on the side of the electrode 122 on the protruding portion 121b. Also, according to the optical modulator 12 of the present embodiment, the protruding portion height H is smaller than the width of the mode field My along the y-axis direction and the protruding portion width W is smaller than the width of the mode field Mx along the x-axis direction. Therefore, according to the optical modulator 12 of the present embodiment, the other part of the optical mode field M excluding the above-described part can be leaked into the inner side of the substrate 121 and the light scattering due to the surface roughness on the side surface of the protruding portion 121b can be suppressed. As a result, according to the optical modulator 12 of the present embodiment, the light propagation loss can be suppressed while improving the modulation efficiency.

According to the embodiment of the optical modulator disclosed by the present application, an effect of suppressing light propagation loss while improving modulation efficiency can be obtained.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical modulator comprising:
a substrate that has a flat portion and a protruding portion protruded from the flat portion;
an electrode supported by the protruding portion; and
an optical waveguide that is formed inside the protruding portion and waveguides light to be modulated with a voltage applied to the electrode, wherein
the protruding portion contains a part, present on a side of the electrode, of a light distribution region over which the light waveguided by the optical waveguide is distributed,
the protruding portion has a tip with a height thereof from the flat portion being smaller than a width of the light distribution region along a protruding direction of the protruding portion, and
the tip of the protruding portion has a width smaller than a width of the light distribution region along a direction perpendicular to the protruding direction of the protruding portion.

2. The optical modulator according to claim 1, wherein the height of the tip of the protruding portion is smaller than 0.6 times the width of the light distribution region along the protruding direction of the protruding portion.

3. The optical modulator according to claim 1, wherein the substrate is formed from any one of LiNbO₃, LiTaO₃, and PLZT.
